(19) United States
(12) Patent Application Publication
(10) Pub. No.: US 2007/0172296 A1
(43) Pub. Date: Jul. 26, 2007

(54) Printer

(75) Inventor: Hitoshi Igarashi, Shiojiri-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/698,470

(22) Filed: Jan. 25, 2007

(30) Foreign Application Priority Data
Jan. 26, 2006 (JP) 2006-017380

(51) Int. Cl. B41J 13/10

(52) U.S. Cl. 400/625

(57) ABSTRACT

A printing head is operable to perform printing on a printing medium at a printing area. A first roller is adapted to transport the printing medium in a first direction toward the printing area. A second roller is disposed in a downstream side of the printing area in the first direction, and is adapted to transport the printing medium in the first direction. A first encoder is operable to detect rotation of the first roller to generate a first detection signal. A second encoder is operable to detect rotation of the second roller to generate a second detection signal. A controller is operable to control the rotation of the first roller and the rotation of the second roller based on the first detection signal and the second detection signal.

### BACKGROUND

1. Technical Field

The present invention relates to a printer.

2. Related Art

Japanese Patent Publication No. 2004-216615A (JP-A-2004-216615) discloses a printer. In this printer, a driving force of a sheet feeding motor is transmitted to a sheet feeding roller by a gear. Further, the driving force is transmitted from a gear attached to the sheet feeding roller to a gear to which the sheet ejecting roller is attached.

As described in JP-A-2004-216615, however, when the driving force transmitted to the sheet feeding roller (sheet supplying roller) is transmitted to the sheet ejecting roller through the gears, it is difficult to stabilize the rotation of the sheet ejecting roller as the rotation of the sheet feeding roller. Therefore, it is likely that the precision in rotation position or velocity of the sheet ejecting roller becomes worse than that precision in the rotation of the sheet feeding roller. Further, when the trailing end portion of sheet is subjected to printing, the sheet is transported on the downstream side of the sheet feeding roller in a sheet transporting direction. Therefore, the sheet is transported by only the sheet ejecting roller. As a result, when the feeding precision of the trailing end portion of the sheet in the sheet ejecting roller is not as stable as the sheet feeding roller, it is likely that the quality of an image to be printed on the trailing end portion of the sheet becomes worse than that of the other portion of the sheet.

### SUMMARY

It is therefore one advantageous aspect of the present invention to provide a printer which can stabilize the rotation of a sheet ejecting roller.

According to one aspect of the invention, there is provided a printer, comprising:

a printing head, operable to perform printing on a printing medium at a printing area;

a first roller, adapted to transport the printing medium in a first direction toward the printing area;

a second roller, disposed in a downstream side of the printing area in the first direction, and adapted to transport the printing medium in the first direction;

a first encoder, operable to detect rotation of the first roller to generate a first detection signal;

a second encoder, operable to detect rotation of the second roller to generate a second detection signal; and

a controller, operable to control the rotation of the first roller and the rotation of the second roller based on the first detection signal and the second detection signal.

According to one aspect of the invention, there is provided a printer, comprising:

a printing head, operable to perform printing on a printing medium at a printing area;

a first roller, adapted to transport the printing medium in a first direction toward the printing area;

a second roller, disposed in a downstream side of the printing area in the first direction, and adapted to transport the printing medium in the first direction;

an encoder, operable to detect rotation of the second roller to generate a detection signal; and

a controller, operable to control the rotation of the first roller and the rotation of the second roller based on the detection signal.

With the above configurations, the rotation of the second roller can be stabilized.

The printer may further comprise: a motor; and a belt, stretched by the motor, the first roller and the second roller. The controller may be operable to control rotation of the motor, thereby controlling the rotation of the first roller and the rotation of the second roller.

With this configuration, the rotation of the motor is directly transmitted to the first roller and the second roller by the belt. Both of the first roller and the second roller are directly driven by the driving force of the motor. The second roller rotates in accordance with the rotation of the motor, similar to the first roller. Further, since the rotational driving force of the motor is directly transmitted to first roller, the first roller rotates to the same precision as that in a case where the force is transmitted by gears. Therefore, the rotation precision of the first roller is not degraded, and the rotation precision of the second roller can be enhanced.

The motor may be disposed in the vicinity of the second roller. The second roller may be abutted against the belt at a position between the motor and the first roller.

With this configuration, the rotational driving force of the motor is more strongly transmitted to the first roller than to the second roller. When the printing medium is transported by the first roller and the second roller, the transport amount of the printing medium can be set to follow the rotation amount of the first roller. Therefore, the first roller can serve as a main roller for medium transporting.

The printer may further comprise a motor, disposed in the vicinity of the second roller, and operable to rotate the first roller and the second roller. The controller may be operable to control rotation of the motor, thereby controlling the rotation of the first roller and the rotation of the second roller.

Since a more sufficient space can be provided in the vicinity of the second roller, in comparison with the vicinity of the first roller, a degree of freedom in design of the printer can be enhanced.

### BRIEF DESCRIPTION OF THE DRAWINGS

FIG. 1 is a schematic side view of a printer according to a first embodiment of the invention.

FIG. 2 is a block diagram showing a control system configuration of the printer.

FIG. 3 is a front view of a scale of a rotary encoder in the printer.

FIG. 4 is a top view of the rotary encoder.

FIG. 5 is a block diagram showing a control system configuration of a printer according to a second embodiment of the invention.

### DETAILED DESCRIPTION OF THE EXEMPLARY EMBODIMENTS

Exemplary embodiments of the invention will be described below in detail with reference to the accompanying drawings. As for the printer, an ink jet printer will be exemplified.

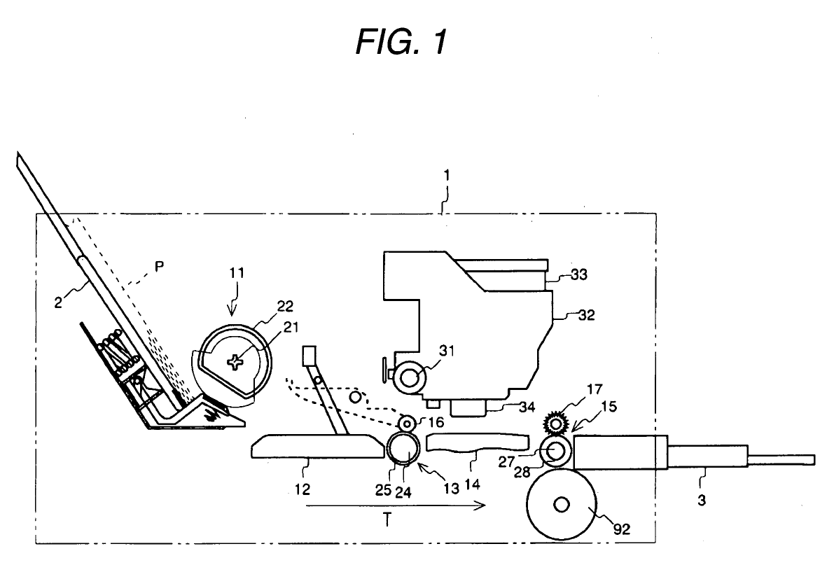

As shown in FIG. 1, an ink jet printer according to a first embodiment of the invention has a housing 1. The housing 1 is formed in a substantially cubical shape and includes a sheet feeding tray 2 and a sheet ejecting tray 3, which are disposed to project outside the housing 1.

The sheet feeding tray 2 is formed in a plate shape. The sheet feeding tray 2 is disposed in the housing 1 such that one end thereof is located inside the housing 1 and the other end thereof projects upward from the housing 1. On the sheet feeding tray 2, a sheet of paper P (hereinafter, simply referred to as “sheet”) as a type of printing medium can be loaded. The sheet P loaded on the sheet feeding tray 2 is positioned in a state where the lower end thereof is abutted on the lower end portion of the sheet feeding tray 2.

The sheet ejecting tray 3 is formed of a stretchable three-stage member, and is disposed in the housing 1 such that one end thereof is located inside the housing 1 and the other end thereof projects from the housing 1 in a substantially horizontal direction.

In addition, the ink jet printer includes a sheet transporting mechanism, which transports the sheet P loaded on the sheet tray 2 to the sheet ejecting tray 3 in the direction shown by an arrow T, and an ink ejecting mechanism which ejects ink onto the sheet P on a sheet transporting path extending from the sheet feeding tray 2 to the sheet ejecting tray 3.

The sheet transporting mechanism mainly includes an load roller 11, a sheet guide 12 formed in a substantially plate shape, a sheet feeding roller 13, a platen 14, and a sheet ejecting roller 15.

The load roller 11 is disposed in a position facing the lower end portion of the sheet feeding tray 2. The load roller 11 includes a roller shaft 21 and an elastic member 22 through which the roller shaft 21 passes. The roller shaft 21 has a cross-shaped cross section. The load roller 11 can rotate in a circumferential direction of the roller shaft 21. As shown in FIG. 1, the elastic member 22 is formed to have a D-shaped cross section where one side of a circular plate is notched, the elastic member 22 being composed of an elastic material, such as rubber. In the lower end portion of the sheet feeding tray 2, for example, a hopper and a separation member may be disposed so as to face the load roller 11.

The sheet feeding roller 13 includes a substantially cylindrical roller shaft 24 and an alumina layer 25 coated on the outer circumferential surface of the roller shaft 24. The alumina layer 25 serves as a slip stopper. On the upper side of the sheet feeding roller 13 in FIG. 1, a follower roller 16 formed in a substantially cylindrical shape is disposed. The outer circumferential portion of the follower roller 16 formed in a cylindrical shape is formed of an elastic member, such as rubber. Further, the follower roller 16 is abutted on the sheet feeding roller 13. As the sheet feeding roller 13 rotates, the follower roller 16 is also rotated.

The platen 14 has a plurality of guide ribs (not shown) formed thereon. The plurality of guide ribs are formed so as to extend along the sheet transporting direction T. The platen 14 may have an ink receiving member, such as sponge, disposed thereon. In this case, it is preferable to dispose the ink receiving member at a lower height than the guide ribs.

The sheet ejecting roller 15 has a substantially cylindrical roller shaft 27 and a plurality of cylindrical members 28 through which the roller shaft 27 passes. The cylindrical members 28 are formed of an elastic material, such as rubber. On the upper side of the sheet ejecting roller 15 in FIG. 1, a plurality of spur members 17 are disposed so as to be abutted on the plurality of cylindrical members 28. Each of the spur members 17 has a plurality of teeth which are continuously formed on the outer circumferential portion thereof. The leading ends of the teeth of the spur members 17 are abutted on the cylindrical members 28. As the sheet ejecting roller 15 rotates, the spur members 17 are also rotated.

The sheet guide 12, the sheet feeding roller 13, the platen 14, and the sheet ejecting roller 15 are arranged in a line along the sheet transporting path between the sheet feeding tray 2 and the sheet ejecting tray 3. Further, on the sheet transporting mechanism, the ink ejecting mechanism is disposed. The ink ejecting mechanism mainly includes a carriage shaft 31, a carriage 32, an ink tank 33, and a recording head 34.

The carriage shaft 31 is formed in a substantially cylindrical shape. The carriage shaft 31 is disposed on the upper side of the sheet feeding roller 13 in the housing 1.

The carriage 32 is held by the carriage shaft 31 so as to be positioned above the platen 14. The carriage 32 can move along the axial direction of the carriage shaft 31.

The ink tank 33 is a container for containing liquid ink. The ink tank 33 is detachably attached on the carriage 32. In ink jet printers, four to eight colors of ink are generally used. One ink tank 33 may contain one color of ink or a plurality of colors of ink therein. In an ink jet printer using a plurality of colors of ink, each of ink tanks 33 may contain only one color of ink. In this case, the ink tanks 33 corresponding to the number of ink colors are disposed on the carriage 32.

The recording head 34 has a plurality of ink ejecting nozzles (not shown). Inside each of the ink ejecting nozzles, a piezoelectric element (not shown) is disposed. When a prescribed voltage pulse is applied, the piezoelectric element is deformed. By the deformation of the piezoelectric element, the ink filled in the ink ejecting nozzle is extruded from the ink ejecting nozzle so as to be ejected. The recording head 34 is disposed in substantially the central portion of the lower surface of the carriage 32 such that the plurality of ink ejecting nozzles face the platen 14.

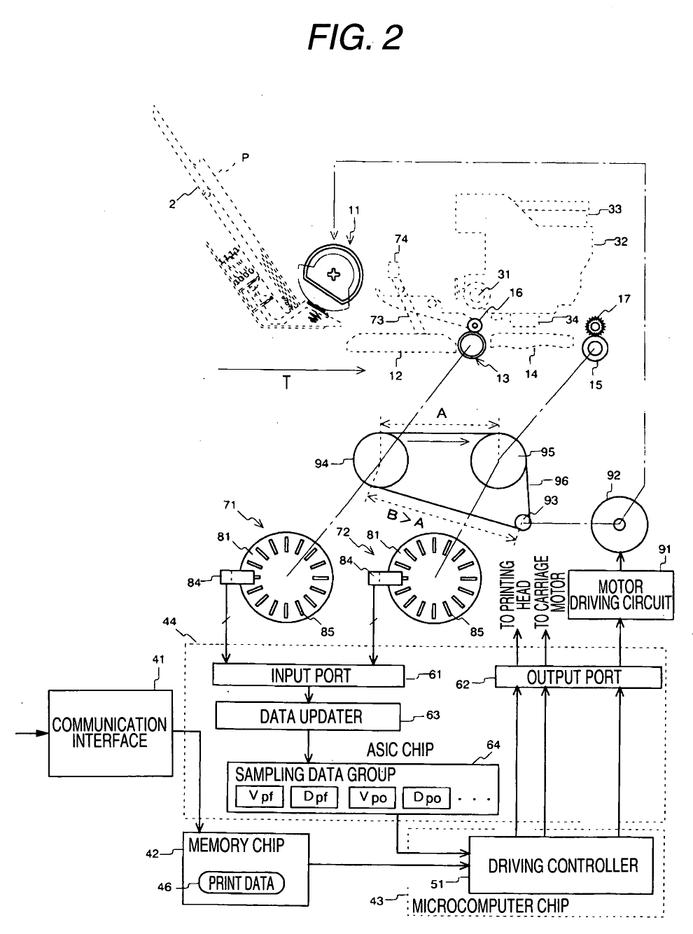

As shown in FIG. 2, the control system of the ink jet printer mainly comprises a communication interface 41, a memory chip 42, a microcomputer chip 43, and an ASIC (application specific integrated circuit) chip 44. The memory chip 42, the microcomputer chip 43, and the ASIC chip 44 are connected to one another by a system bus (not shown).

The communication interface 41 is connected to the ASIC chip 44. The communication interface 41 has a connector (not shown) to which a USB (universal serial bus) cable, an ink jet printer cable, an SCSI (small computer system interface) cable and the like can be connected. The communication interface 41 receives print data from a host computer (not shown) through the connector. The communication interface 41 may be connected with the host computer in a wireless communication manner through, for example, Bluetooth or wireless LAN (local area network).

The memory chip 42 stores print data 46. As for the print data 46, there is provided data described by a page-description language, such as ESC (Epson standard code)/Page or PostScript. For example, the print data 46 described by the page-description language is generated when a host computer (not shown) designates a printer which will performs printing. The print data 46 to be received by the printer is described in the format according to the specification of the printer. For example, the print data 46, which is described for an ink jet printer by a page-description language, has generally a format in which printing-medium feed control data and ink ejecting control data are alternately described. Further, the memory chip 42 may store JPEG (joint photographic coding experts group) format image data as the print data 46.

The microcomputer chip 43 executes an ink jet printer control program (not shown) such that a driving controller 51 is implemented. The driving controller 51 performs printing control in accordance with the print data 46.

The ASIC chip 44 has an input port 61 and an output port 62. Further, the ASIC chip 44 executes an ASIC chip program (not shown) such that a data updater 63 is implemented. The data updater 63 samples a signal input to the input port 61. The data updater 63 updates a sampling data group 64 by using sampled data. The sampling data group 64 includes detection velocity Vpf of the sheet feeding roller 13, a rotation amount Dpf of the sheet feeding roller 13, detection velocity Vpo of the sheet ejecting roller 15, a rotation amount Dpo of the sheet ejecting roller 15, and so on. The sampling data group 64 is stored in a RAM (not shown) of the ASIC chip 44, for example.

The ink jet printer control program executed by the microcomputer chip 43 and the ASIC chip program executed by the ASIC chip 44 may be stored in the memory chip 42, for example. Those programs may be stored in an ink jet printer before or after the ink jet printer is shipped. The program to be stored in an ink jet printer after the inject printer is shipped may be read from a recording medium, such as a CD-ROM, which can be read by a computer or may be downloaded through a transfer medium such as an electric communication line. Further, only portions of those programs may be updated and stored after an ink jet printer is shipped.

The input port 61 of the ASIC chip 44 is connected to a sheet feeding encoder 71 and a sheet ejecting encoder 72. In addition, the input port 61 of the ASIC chip 44 is connected to a sheet feeding sensor 74 for detecting a rotation state of a retract lever 73, as shown in FIG. 2. When the retract lever 73 is pushed up by a printing medium, such as sheet P, so as to rotate, the sheet feeding sensor 74 outputs a detection signal.

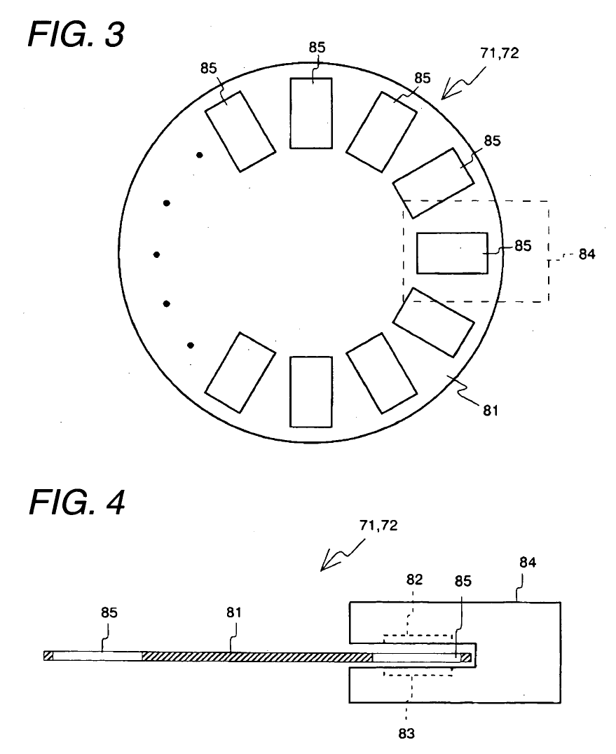

As shown in FIGS. 3 and 4, a rotary encoder used as the sheet feeding encoder 71 and the sheet ejecting encoder 72 has a circular plate 81 and a transmission-type optical sensor 84 in which a light emitting element 82 and a plurality of light receiving elements 83 are disposed so as to face each other.

In the circular plate 81 of the rotary encoder, a plurality of slits 85 are formed. As shown in FIG. 3, the plurality of slits 85 are formed so as to be spaced at a prescribed distance from each other along the outer circumference of the circular plate 81. As shown in FIG. 4, the transmission-type optical sensor 84 of the rotary encoder is a box-shaped body in which a groove is formed. In the transmission-type optical sensor 84, the light emitting element 82 and the plurality of light receiving elements 83 are disposed so as to face each other through the slit.

The transmission-type optical sensor 84 is disposed so that the outer circumferential portion of the circular plate 81 enters the groove between the light emitting element 82 and the plurality of light receiving elements 83. When the slit 85 is positioned between the light emitting element 82 and the light receiving element 83, the light receiving element 83 receives light from the light emitting element 82 so as to output a light reception signal indicating a state where light is received. When the portion of the circular plate 81 between the slit 85 and the adjacent slit 85 is positioned between the light receiving element 83 and the light emitting element 82, light is blocked, and the light receiving element 83 outputs a light reception signal indicating a state where light is blocked. When the circular plate 81 rotates, the light receiving element 83 outputs a light reception signal, which changes in a pulse manner as the amount of received light varies.

When an interval between the adjacent slits 85 is corresponded to one cycle, the plurality of light receiving elements 83 are formed so as to be arranged at each distance corresponding to a phase of 90 degrees of the cycle. Based on a plurality of light reception signals to be generated by the plurality of light receiving elements 83, the rotary encoder outputs light reception signals for four channels, of which the phases are shifted from each other by 90 degrees.

Returning to FIG. 2, the description is continued. The circular plate 81 of the rotary encoder to be used as the sheet feeding encoder 71 is constructed so as to integrally move with the sheet feeding roller 13. Accordingly, the circular plate 81 rotates together with the sheet feeding roller 13. Further, the rotary encoder to be used as the sheet feeding encoder 71 outputs light reception signals for four channels to the input port 61 of the ASIC chip 44.

The circular plate 81 of the rotary encoder to be used as the sheet ejecting encoder 72 is constructed so as to integrally move with the sheet ejecting roller 15. Accordingly, the circular plate 81 rotates together with the sheet ejecting roller 15. Further, the rotary encoder to be used as the sheet ejecting encoder 72 outputs light reception signals for four channels to the input port 61 of the ASIC chip 44.

The output port 62 of the ASIC chip 44 is connected to a motor driving circuit 91. In addition, the output port 62 of the ASIC chip 44 is connected to the plurality of piezoelectric elements of the recording head 34 and a circuit (not shown) for driving the carriage 32.

The motor driving circuit 91 drives a sheet feeding motor 92. The sheet feeding motor 92 rotates a rotation shaft which is directly or indirectly connected to a rotor. The rotating shaft of the sheet feeding motor 92 is engaged with a driving pulley 93. Accordingly, the driving pulley 93 rotates together with the rotating shaft of the sheet feeding motor 92.

The sheet feeding roller 13 is engaged with a sheet feeding pulley 94 such that the sheet feeding pulley 94 moves together with the sheet feeding roller 13. As a result, the sheet feeding pulley 94 rotates together with the sheet feeding roller 13 and the circular plate 81 of the rotary encoder to be used as the sheet feeding encoder 71. Further, the sheet ejecting roller 15 is engaged with a sheet ejecting pulley 95 such that the sheet ejecting pulley 95 moves together with the sheet ejecting roller 15. As a result, the sheet ejecting pulley 95 rotates together with the sheet ejecting roller 15 and the circular plate 81 of the rotary encoder to be used as the sheet ejecting encoder 72.

Around the driving pulley 93, the sheet feeding pulley 94, and the sheet ejecting pulley 95, a driving belt 96 is stretched with tension where the driving belt 96 hardly slides on the driving pulley 93, the sheet feeding pulley 94, and the sheet ejecting pulley 95. The driving belt 96 is adapted to be circulated by the driving pulley 93, the sheet feeding pulley 94 and the sheet ejecting pulley 95 in a direction C.

As shown in FIG. 1, the sheet feeding motor 92 is disposed on the lower side of the sheet ejecting roller 15 so as to be placed closer to the sheet ejecting tray 3 than the sheet ejecting roller 15. Therefore, as shown in FIG. 2, the rotation center of the sheet ejecting pulley 95 is disposed between the rotation center of the driving pulley 93 and the rotation center of the sheet feeding pulley 94 and is abutted on the middle of the driving belt 96 which is stretched around the driving pulley 93 and the sheet feeding pulley 94. The distance A between the rotation center of the sheet feeding pulley 94 and the rotation center of the sheet ejecting pulley 95 is smaller than the distance B between the rotation center of the sheet feeding pulley 94 and the rotation center of the driving pulley 93. An angle (area) where the sheet feeding pulley 94 comes in contact with the driving belt 96 is larger than an angle (area) where the sheet ejecting pulley 95 comes in contact with the driving belt 96. As a result, the sheet feeding pulley 94 is more slip-resistant to the driving belt 96 than the sheet ejecting pulley 95.

In addition, the sheet feeding motor 92 rotates the load roller 11 through a gear train or a pulley.

Next, the operation of the ink jet printer having such a construction will be described.

The communication interface 41 receives print data 46 from a host computer (not shown). The print data 46 received by the communication interface 41 is supplied to the memory chip 42 through the ASIC chip 44. The memory chip 42 stores the supplied print data 46.

When the print data 46 is stored in the memory chip 42, the driving controller 51 to be implemented in the microcomputer chip 43 starts sheet supplying control.

Specifically, the driving controller 51 instructs the drive start of the sheet feeding motor 92, based on processing data to be described in the head of the print data 46. The drive start instruction is supplied through the output port 62 of the ASIC chip 44 to the motor driving circuit 91. The motor driving circuit 91 starts driving the sheet feeding motor 92.

When the sheet feeding motor 92 is driven, the load roller 11 rotates. The outer circumferential surface of the load roller 11 having a substantially D-shaped cross section is abutted on the sheet P which is positioned uppermost on the sheet feeding tray 2. The sheet P abutted on the load roller 11 is supplied from the sheet feeding tray 2 to the sheet transporting path in accordance with the rotation of the load roller 11. The leading end of the sheet P extruded by the rotation of the load roller 11 is transported on the sheet guide 12. Then, a retractable lever 73 is pushed up so that the leading end of the sheet P is supplied between the sheet feeding roller 13 and the follower roller 16.

When the sheet feeding motor 92 is driven, a driving force is transmitted to the sheet feeding roller 13 through the driving pulley 92, the driving belt 96, and the sheet feeding pulley 94. The sheet feeding roller 13 and the follower roller 16 are rotated. The leading end of the sheet P is interposed between the sheet feeding roller 12 and the follower roller 16. The sheet P interposed by the sheet feeding roller 13 and the follower roller 16 is supplied between the carriage 32 and the platen 14 in accordance with the rotation of the sheet feeding roller 13. After that, the load roller 11 stops rotating, when a prescribed 360-degree rotation thereof is completed.

The circular plate 81 of the sheet feeding encoder 71 rotates together with the sheet feeding roller 13. Based on the light reception states of the plurality of light receiving elements 83, the sheet feeding encoder 71 generates light reception signals for four channels and then outputs the signals to the input port 61 of the ASIC chip 44.

When the sheet feeding motor 92 is driven, a driving force is transmitted to the sheet ejecting roller 15 through the driving pulley 93, the driving belt 96, and the sheet ejecting pulley 95. The sheet ejecting roller 15 and the plurality of spur members 17 are rotated. Further, the circular plate 81 of the sheet ejecting encoder 72 rotates together with the sheet ejecting roller 15. Based on the light reception states of the plurality of light receiving elements 83, the sheet ejecting encoder 72 generates light reception signals for four channels and then outputs the signals to the input port 61 of the ASIC chip 44.

The data updater 63 implemented by the ASIC chip 44 periodically samples those light reception signals to be input to the input port 61. The data updater 63 updates a sampling data group 64 by using the sampled data. Further, a sampling cycle of the data updater 63 may be set to range from several micro seconds to several hundreds of micro seconds.

For example, the data updater 63 updates the detection velocity Vpf of the sheet feeding roller 13, based on the pulse number of the light reception signals for four channels from the sheet feeding encoder 71 per unit time. The data updater 63 updates the rotation amount Dpf of the sheet feeding roller 13, based on the number of accumulated pulses of the light reception signals for four channels from the sheet feeding encoder 71. Further, the data updater 63 updates the detection velocity Vpo of the sheet ejecting roller 15, based on the pulse number of the light reception signals for four channels from the sheet ejecting encoder 72 per unit time. The data updater 63 updates the rotation amount Dpo of the sheet ejecting roller 15, based on the number of accumulated pulses of the light reception signals for four channels from the sheet ejecting encoder 72.

The driving controller 51 acquires the sampling data group 64 from the ASIC chip 44. Based on the sampling data of a detection signal of the sheet feeding sensor 74, the driving controller 51 detects that the leading end of the sheet P is caught by the sheet feeding roller 13. The driving controller 51 instructs the termination of sheet feeding, when the sheet P is transported by a prescribed distance after the detection. The prescribed distance may be determined based on the average value of the rotation amount Dpf of the sheet feeding roller 13 and the rotation amount Dpo of the sheet ejecting roller 15.

When the instruction to terminate sheet feeding is made, the motor driving circuit 91 stops the sheet feeding motor 92. The sheet feeding roller 13, the follower roller 16, the sheet ejecting roller 15, and the plurality of spur members 17 stop rotating. The sheet P is stopped at a position where the leading end thereof is positioned between the recording head 34 and the platen 14.

When the sheet supplying control is terminated, the driving controller 51 starts reading the print data 46 from the memory chip 42. Based on the read print data 46, the driving controller 51 starts ink ejecting control. Further, the reading of the print data 46 may be performed before the sheet supplying control begins, at the same time when the sheet supplying control begins, or while the sheet supplying control is performed.

Specifically, the driving controller 51 outputs an instruction for driving the carriage driving motor (not shown) to the output port 62 of the ASIC chip 44. Further, the driving controller 51 outputs an instruction of ink ejecting control to the recording head 34, based on the ink ejecting control data read from the print data 46. Accordingly, the carriage 32 moves in a primary scanning direction, and ink is ejected from the plurality of ink ejecting nozzles (not shown) of the recording head 34. The ink ejected from the plurality of ink ejecting nozzles is adhered on the leading end portion of the sheet P.

When the ink ejecting control based on the read print data 46 is terminated, the driving controller 51 reads the rest of the print data 46 from the memory chip 42. The driving controller 51 starts sheet transporting control. Moreover, the print data 46 does not need to be newly read by the driving controller 51, but the whole print data may be read for the first time such that the successive control is performed.

Specifically, the driving controller 51 outputs an instruction to drive the sheet feeding motor 92 to the output port 62 of the ASIC chip 44. The motor driving circuit 91 drives the sheet feeding motor 92. The rotational driving force of the sheet feeding motor 92 is transmitted to the sheet feeding roller 13 and the sheet ejecting roller 15 through the driving pulley 93, the driving belt 96, the sheet feeding pulley 94, and the sheet ejecting pulley 95. The sheet feeding roller 13 and the sheet ejecting roller 15 are rotated, so that the sheet P is transported toward the downstream side (the side of the sheet ejecting tray 3) in the sheet transporting direction T.

When the sheet feeding roller 13 and the sheet ejecting roller 15 are rotated, the sheet feeding encoder 71 and the sheet ejecting encoder 72 output light reception signals with pulses. The data updater 63 updates the sampling data group 64, based on the pulses of the light reception signals from the sheet feeding encoder 71 and the sheet ejecting encoder 72. When the sheet is transported by a prescribed distance, the driving controller 51 instructs the termination of sheet feeding. For example, when the average value of the rotation amount Dpf of the sheet feeding roller 13 and the rotation amount Dpo of the sheet feeding roller 15 becomes the prescribed distance, the driving controller 51 instructs the termination of sheet feeding.

When the instruction to terminate sheet feeding is made, the motor driving circuit 91 stops the sheet feeding motor 92. The sheet feeding roller 13, the follower roller 16, the sheet ejecting roller 15, and the plurality of spur members 17 stop rotating. Further, the sheet P transported by the prescribed distance is then stopped.

As such, the driving controller 51 sequentially reads the control data described in the print data 46 from the head of the print data 46 or collectively reads the control data so as to alternately execute the ink ejecting control and the sheet transporting control. For example, when it is checked that the print data 46 is read to the last thereof or the print data 46 is completely executed, the driving controller 51 starts sheet ejecting control.

Specifically, the driving controller 51 outputs an instruction to drive the sheet feeding motor 92 to the output port 62 of the ASIC chip 44. The motor driving circuit 91 drives the sheet feeding motor 92. The rotational driving force of the sheet feeding motor 92 is transmitted to the sheet feeding roller 13 and the sheet ejecting roller 15 through the driving pulley 93, the driving belt 96, the sheet feeding pulley 94, and the sheet ejecting pulley 95. The sheet feeding roller 13 and the sheet ejecting roller 15 are rotated. As the sheet feeding roller 13 and the sheet ejecting roller 15 are rotated, the sheet P is transported toward the downstream side of the printing medium transport direction.

As the sheet feeding roller 13 and the sheet ejecting roller 15 are rotated, the sheet feeding encoder 71 and the sheet ejecting encoder 72 output light reception signals which change in a pulse manner. Based on the pulses of the light reception signals from the sheet feeding encoder 71 and the sheet ejecting encoder 72, the data updater 63 updates the sampling data group 64. When the sheet is transported by a prescribed distance, the driving controller 51 instructs the termination of sheet ejecting. The prescribed distance may be a distance by which the trailing end of the sheet P moves from the sheet feeding roller 13 to the sheet ejecting tray 3. When the average value of the rotation amount Dpf of the sheet feeding roller 13 and the rotation amount Dpo of the sheet ejecting roller 15 becomes the prescribed distance, the driving controller 51 instructs the termination of sheet ejecting.

When the instruction to terminate sheet ejecting is made, the motor driving circuit 91 stops the sheet feeding motor 92. The sheet feeding roller 13, the follower roller 16, the sheet ejecting roller 15, and the plurality of spur members 17 stop rotating. The sheet P which has been subjected to printing is ejected to the sheet ejecting tray 3.

The driving controller 51 may perform velocity control such that the transport velocity of the sheet P becomes a prescribed transport value during the sheet feeding, the sheet transporting, or the sheet ejecting. In this case, it is preferable that the driving controller 51 perform control such that the average value of the detection velocity Vpf of the sheet feeding roller 13 and the detection velocity Vpo of the sheet ejecting roller 15 becomes the prescribed transport velocity.

As described above, in the first embodiment, the rotation amount of the sheet feeding roller 13 and the rotation amount of the sheet ejecting roller 15 are detected and controlled by the driving controller 51. Therefore, the rotation of the sheet ejecting roller 15 is stabilized.

In the first embodiment, the rotation of the sheet feeding motor 92 is directly transmitted to the sheet feeding roller 13 and the sheet ejecting roller 15 by the driving belt 96. Both of the sheet feeding roller 13 and the sheet ejecting roller 15 are directly driven by a driving force of the sheet feeding motor 92. The sheet ejecting roller 15 is rotated in accordance with the rotation of the sheet feeding motor 92, similar to the sheet feeding roller 13. Further, since the rotational driving force of the sheet feeding motor 92 is directly transmitted to the sheet feeding roller 13, the sheet feeding roller 13 is rotated to the same precision as the case where the force is transmitted by gears. Therefore, the rotational precision of the sheet feeding roller 13 is not degraded, and the rotational precision of the sheet ejecting roller 15 is enhanced.

In addition, the rotational driving force of the sheet feeding motor 92 is more strongly transmitted to the sheet feeding roller 13 than to the sheet ejecting roller 1.5. Therefore, when a printing medium, such as the sheet P, is transported by the sheet feeding roller 13 and the sheet ejecting roller 15, the transport amount of the printing medium follows the rotation amount of the sheet feeding roller 13. The sheet feeding roller 13 can serve as a main roller for sheet transporting.

Also, in the first embodiment, the sheet feeding motor 92 for rotating the sheet feeding roller 13 and the sheet ejecting roller 15 is disposed around the sheet ejecting roller 15. The sheet feeding motor 92 is disposed in a position separated from the sheet feeding roller 13. Around the sheet ejecting roller 15, a more sufficient space is provided than around the sheet feeding roller 13. Therefore, a degree of freedom in design of the printer increases.

Furthermore, in the first embodiment, the driving controller 51 performs control operation based on the average of the detected rotation amount of the sheet feeding roller 13 and the detected rotation amount of the sheet ejecting roller 15. However, the driving controller 51 may control the rotation of the sheet feeding roller 13 and the rotation of the sheet ejecting roller 15 by using the detected rotation amount of only one of the sheet feeding roller 13 and the sheet ejecting roller 15. Alternately, the driving controller 51 may control the rotation of the sheet feeding roller 13 and the detected rotation amount of the sheet ejecting roller 15 by using the detected rotation amount of the sheet feeding roller 13 and the detected rotation amount of the sheet ejecting roller 15 at a prescribed ratio.

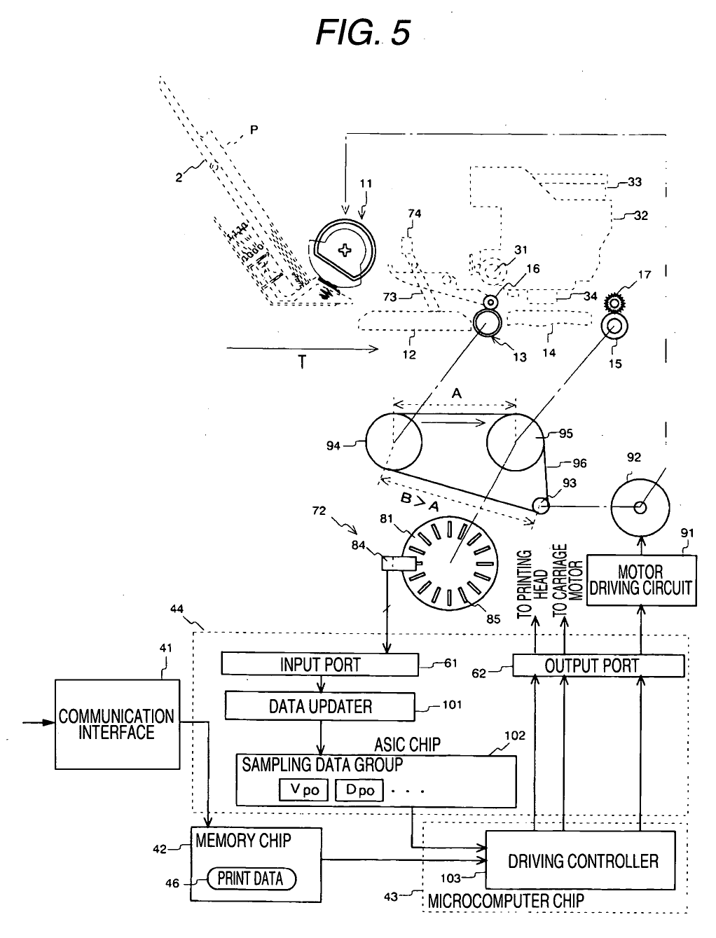

FIG. 5 shows an ink jet printer according to a second embodiment of the invention. In this embodiment, the sheet feeding encoder shown in FIG. 2 is omitted.

A data updater 101 updates a sampling data group 102, consisting of the detection velocity Vpo of the sheet ejecting roller 15, the rotation amount Dpo of the sheet ejecting roller 15, and so on, by using sampled data.

Based on the rotation detected by a sheet ejecting encoder 72, a driving controller 103 controls the rotation of the sheet feeding roller 13 and the rotation of the sheet ejecting roller 15.

Constituent elements other than the above-described elements have the same serves as those of the constituent elements of the ink jet printer according to the first embodiment. Therefore, like reference numerals designate the same elements, and repetitive explanations for those will be omitted.

Next, the operation of the ink jet printer having such a construction will be described.

When a sheet supplying control instruction, a sheet transporting control instruction, and a sheet ejecting control instruction are made from the driving controller 103, the motor driving circuit 91 starts the drive of the sheet feeding motor 92. When the sheet feeding motor 92 is driven, the load roller 11, the driving pulley 93, the driving belt 96, the sheet feeding pulley 94, the sheet feeding roller 13, the follower roller 16, the sheet ejecting pulley 95, the sheet ejecting roller 15, and the plurality of spur members 17 are rotated.

When the sheet supplying control instruction is made, the sheet P on the sheet feeding tray 2 is transported to a position facing the recording head 34. When the sheet transporting control instruction is made, the sheet P located in the position facing the recording head 34 is transported by a prescribed amount. When the sheet ejecting control instruction is made, the sheet P located in the position facing the recording head 34 is transported to the sheet ejecting tray 3.

The circular plate 81 of the sheet ejecting encoder 72 rotates together with the sheet ejecting roller 15. Based on the light reception states of the plurality of light receiving elements 83, the sheet ejecting encoder 72 generates light reception signals for four channels and then outputs the signals to the input port 61 of the ASIC chip 44.

The data updater 101 implemented in the ASIC chip 44 periodically samples those light reception signals input to the input port 61. The data updater 101 updates the sampling data group 102 by using the sampled data. Specifically, based on the pulse number of the light reception signals for four channels from the sheet ejecting encoder 72 per unit time, the data updater 101 updates the detection velocity Vpo of the sheet ejecting roller 15. Based on the number of accumulated pulses of the light reception signals for four channels from the sheet ejecting encoder 72, the data updater 101 updates the rotation amount Dpo of the sheet ejecting roller 15.

The driving controller 103 acquires the sampling data group 102 from the ASIC chip 44. When the rotation amount Dpo of the sheet ejecting roller 15 becomes a prescribed distance according to the control, the driving controller 103 instructs the termination. When the instruction of the termination is made, the motor driving circuit 91 stops the sheet feeding motor 92. The sheet P is transported to a prescribed position according to the control.

Also, the driving controller 103 performs velocity control such that the detection velocity Vpo of the sheet ejecting roller 15 becomes prescribed value. When the detection velocity Vpo of the sheet ejecting roller 15 is larger than the prescribed value, the driving controller 103 supplies an instruction to lower the velocity to the motor driving circuit 91. When the detection velocity Vpo of the sheet ejecting roller 15 is smaller than the prescribed value, the driving controller 103 supplies an instruction to raise the velocity to the motor driving circuit 91. Accordingly, the sheet transport velocity is controlled so as to approach the prescribed value.

The operation excluding the above-described operation is the same as that of the first embodiment, and a description thereof will be omitted.

As such, in the second embodiment, the driving controller 103 detects the rotation amount of the sheet ejecting roller 15 and controls the rotation amount of the sheet ejecting roller 15 and the rotation amount of the sheet feeding roller 13 for transporting a printing medium. Therefore, the rotation of the sheet ejecting roller 15 is stabilized.

In the second embodiment, the rotation of the sheet feeding motor 92 is directly transmitted to the sheet feeding roller 13 and the sheet ejecting roller 15 by the driving belt 96 and so on. Both of the sheet feeding roller 13 and the sheet ejecting roller 15 are directly driven by a driving force of the sheet feeding motor 92. The sheet ejecting roller 15 rotates in accordance with the rotation of the sheet feeding motor 92, similar to the sheet feeding roller 13. Further, since the rotational driving force of the sheet feeding motor 92 is directly transmitted to the sheet feeding roller 13, the sheet feeding roller 13 rotates to the same precision as that in a case where the force is transmitted by gears. Therefore, the rotation precision of the sheet feeding roller 13 is not degraded, and the rotation precision of the sheet ejecting roller 15 is enhanced.

In addition, the rotational driving force of the sheet feeding motor 92 is more strongly transmitted to the sheet feeding roller 13 than to the sheet ejecting roller 15. Therefore, when a printing medium, such as the sheet P, is transported by the sheet feeding roller 13 and the sheet ejecting roller 15, the transported amount of the printing medium follows the rotation amount of the sheet feeding roller 13. The sheet feeding roller 13 can serve as a main roller for sheet transporting.

Also, in the second embodiment, the sheet feeding motor 92 for rotating the sheet feeding roller 13 and the sheet ejecting roller 15 is disposed around the sheet ejecting roller 15. The sheet feeding motor 92 is disposed in a position separated from the sheet feeding roller 13. Around the sheet ejecting roller 15, a more sufficient space is provided than around the sheet feeding roller 13. Therefore, a degree of freedom in design of the printer increases.

Although only some exemplary embodiments of the invention have been described in detail above, those skilled in the art will readily appreciated that many modifications are possible in the exemplary embodiments without materially departing from the novel teachings and advantages of the invention. Accordingly, all such modifications are intended to be included within the scope of the invention.

For example, in the respective embodiments, the rotation of the sheet feeding motor 92 is transmitted to the sheet feeding roller 13 and the sheet ejecting roller 15 by the driving belt 96. However, the rotation of the sheet feeding motor 92 may be transmitted to the sheet feeding roller 13 and the sheet ejecting roller 15 by gears.

In the individual embodiments, the driving controllers 51 and 103 for controlling the rotation of the sheet feeding roller 13 and the rotation of the sheet ejecting roller 15 are implemented in the microcomputer chip 43. However, the driving controllers 51 and 103 may be implemented in the ASIC chip 44 or may be implemented in both of the microcomputer chip 43 and the ASIC chip 44.

In the respective embodiments, the sheet feeding encoder 71 for detecting the rotation of the sheet feeding roller 13 and the sheet ejecting encoder 72 for detecting the rotation of the sheet ejecting roller 15 have the same function of four-channel output. However, the sheet feeding encoder 71 and the sheet ejecting encoder 72 may have a function of two-channel output. Alternately, it is possible that one of them has a function of two-channel output and the other has a function of four-channel output.

In the respective embodiments, a sheet of paper is used as a printing medium. As for the printing medium, a film sheet, such as OHP, a peelable sheet, such as seal, and a recording medium, such as CD, may be available.

In the respective embodiments, a light-transmission-type encoder having the light emitting element and the light reception elements is used as the sheet feeding encoder 71 or the sheet ejecting encoder 72. However, a light-reflection-type encoder, a magnetic encoder or the like may be used as the sheet feeding encoder 71 or the sheet ejecting encoder 72.

In this specification, the vicinity of the sheet ejecting roller 15 is referred to as the downstream side from the center of the platen 14 in the sheet transporting direction T. More preferably, the vicinity of the sheet ejecting roller 15 is referred to as positions overlapping with the sheet ejecting roller 15 in the vertical direction.

In the respective embodiments, the ink jet printer has been exemplified. In addition, the above-described construction can be applied to multi-function printers having a scanner function, a copier function, etc. or laser printers.

The disclosure of Japanese Patent Application No. 2006-17380 filed Jan. 26, 2006 including specification, drawings and claims is incorporated herein by reference in its entirety.

What is claimed is:

1. A printer, comprising:
a printing head, operable to perform printing on a printing medium at a printing area;
a first roller, adapted to transport the printing medium in a first direction toward the printing area;
a second roller, disposed in a downstream side of the printing area in the first direction, and adapted to transport the printing medium in the first direction;
a first encoder, operable to detect rotation of the first roller to generate a first detection signal;
a second encoder, operable to detect rotation of the second roller to generate a second detection signal; and
a controller, operable to control the rotation of the first roller and the rotation of the second roller based on the first detection signal and the second detection signal.

2. The printer as set forth in claim 1, further comprising:
a motor; and
a belt, stretched by the motor, the first roller and the second roller, wherein:
the controller is operable to control rotation of the motor, thereby controlling the rotation of the first roller and the rotation of the second roller.

3. The printer as set forth in claim 2, wherein:
the motor is disposed in the vicinity of the second roller; and
the second roller is abutted against the belt at a position between the motor and the first roller.

4. The printer as set forth in claim 1, further comprising:
a motor, disposed in the vicinity of the second roller, and operable to rotate the first roller and the second roller, wherein:
the controller is operable to control rotation of the motor, thereby controlling the rotation of the first roller and the rotation of the second roller.

5. A printer, comprising:
a printing head, operable to perform printing on a printing medium at a printing area;
a first roller, adapted to transport the printing medium in a first direction toward the printing area;
a second roller, disposed in a downstream side of the printing area in the first direction, and adapted to transport the printing medium in the first direction;
an encoder, operable to detect rotation of the second roller to generate a detection signal; and
a controller, operable to control the rotation of the first roller and the rotation of the second roller based on the detection signal.

6. The printer as set forth in claim 5, further comprising:
a motor; and
a belt, stretched by the motor, the first roller and the second roller, wherein:
the controller is operable to control rotation of the motor, thereby controlling the rotation of the first roller and the rotation of the second roller.

7. The printer as set forth in claim 6, wherein:
the motor is disposed in the vicinity of the second roller; and
the second roller is abutted against the belt at a position between the motor and the first roller.

8. The printer as set forth in claim 5, further comprising:
a motor, disposed in the vicinity of the second roller, and operable to rotate the first roller and the second roller, wherein:
the controller is operable to control rotation of the motor, thereby controlling the rotation of the first roller and the rotation of the second roller.
